(19) United States
(12) Patent Application Publication
(10) Pub. No.: US 2019/0163852 A1
(43) Pub. Date: May 30, 2019

(54) HEATING SIMULATION METHOD, HEATING SIMULATION PROGRAM, AND HEATING SIMULATION DEVICE INCLUDING STORAGE MEDIUM HAVING SAID PROGRAM STORED THEREIN

(71) Applicant: HISAKA WORKS, LTD., Osaka-shi, Osaka (JP)

(72) Inventors: Hirokazu Negoro, Higashi-Osaka-shi, Osaka (JP); Isamu Mukai, Amagaski-shi, Hyogo (JP); Kota Ukai, Higashi-Osaka-shi, Osaka (JP)

(21) Appl. No.: 16/301,353

(22) PCT Filed: May 17, 2017
(86) PCT No.: PCT/JP2017/018448

§ 371 Date: Nov. 13, 2018

(30) Foreign Application Priority Data
May 31, 2016 (JP) 2016-108856

(51) Int. Cl. G06F 17/50; G06F 17/17

(52) U.S. Cl. CPC G06F 17/5009; G06F 2217/80; G06F 17/17

(57) ABSTRACT

In a heating simulation method, a first physical property value and a second physical property value are set as a physical property value of an object to be heated, a temperature at which the physical property value of the object changes from the first physical property value to the second physical property value is set as a conversion temperature, the temperature change of the object is calculated using the first physical property value as the physical property value of the object in the case where a calculated temperature of the object is lower than the conversion temperature, and the temperature change of the object is calculated using the second physical property value as the physical property value of the object in the case where the calculated temperature of the object is equal to or higher than the conversion temperature.

### CROSS-REFERENCE TO RELATED APPLICATION

This application claims priority to Japanese Patent Application No. 2016-108856, the disclosure of which is incorporated herein by reference in its entirety.

### FIELD

The present invention relates to a heating simulation method for calculating temperature change of an object that is being heated, a heating simulation program, and a heating simulator including a storage medium having the program stored therein.

### BACKGROUND

In manufacturing packed food, such as canned food and retort food, the manufactured packed food is conventionally heat sterilized. Whether or not a certain heating condition is suitable for food sterilization is generally evaluated using an F-value, which is a sterilization value expressed in a relation between temperature and time. In the case where the temperature history of food under a certain heating condition meets a predetermined F-value, it can be evaluated that the heating condition is suitable for food sterilization. For example, an F-value of retort food is required to be equivalent to 4 minutes at 120.0° C. or greater, pursuant to the Food Sanitation Act.

The temperature history of food can also be obtained through measurements of the temperature of the food that is being heated using a sensor or the like; however, it requires costs and time to obtain the temperature histories of foods having different shapes and sizes through the measurements. In order to reduce these costs and time, a simulation method using the computer for calculating an estimated temperature of food that is being heated is widely used (see, for example, Patent Literature 1). The estimated temperature of food is calculated using, for example, an arithmetic expression derived from the ATS method (Ambient Temperature Slide method; see, for example, Non-patent Literature 1). Specifically, the heating conditions and physical property value of the food (for example, heat transfer coefficient) are set in the simulator, and the estimated temperature is calculated by the simulator using the arithmetic expression based on the heating conditions and the physical property value. A similar simulation is used also for calculating an estimated temperature of an object other than food, such as a medicinal product, that is being heated.

### CITATION LIST

### Patent Literature

Patent Literature 1; JP 3071412 B

### Non-Patent Literature

Non-patent Literature 1; Mukai, Isamu and 1 other, “Clarification of the Theoretical Problem in ATS Method by Using Similarity Relation within Temperature History Curves”, Japan Journal of Food Engineering, Vol. 16, No. 3, pp. 209-217, September 2015

### SUMMARY

### Technical Problem

As aforementioned, the physical property value of the object needs to be firstly set to calculate the estimated temperature of the object through the simulation; however, when the physical property value of the object is unknown, simulations are performed using a temporarily set physical property value, and the physical property value is obtained using a trial-and-error method. Specifically, a series of steps of: estimating a physical property value of the object; performing a simulation using the estimated physical property value to calculate an estimated temperature; comparing the calculated estimated temperature with the measured temperature; correcting the estimated physical property value so as to make small the difference between these temperatures; comparing an estimated temperature calculated through another simulation using the corrected physical property value, with the measured temperature of the object; and correcting the physical property value so as to make smaller the difference between these temperatures, is repeatedly carried out until the difference between the estimated temperature and the measured temperature is sufficiently small. The physical property value having the difference sufficiently small is used as the physical property value for calculating the estimated temperature of the object. In some objects, however, the difference between the estimated temperature and the measured temperature is not sufficiently made small even after the physical property value is repeatedly corrected.

In view of the above circumstances, the present invention is to provide a simulation method capable of calculating estimated temperatures approximate to the actual temperature change of the object.

### Solution to Problem

As a result of their diligent studies on the aforementioned problem, the inventors have found that the aforementioned object has its physical properties changed when the object is heated to a specific temperature, and that simulations in consideration of the change in the physical properties allow the estimated temperature of the object obtained by the simulations to be approximate to the measured temperature of the object.

The heating simulation method according to the present invention is a heating simulation method for obtaining, by calculation, temperature change of an object to be heated under a predetermined heating condition, which includes: setting a first physical property value and a second physical property value as a physical property value of the object to be heated; setting a temperature at which the physical property value of the object to be heated changes from the first physical property value to the second physical property value, as a conversion temperature; calculating the temperature change of the object to be heated using the first physical property value as the physical property value of the object to be heated in the case where a calculated temperature of the object to be heated is lower than the conversion temperature; and calculating the temperature change of the object to be heated using the second physical property value as the physical property value of the object to be heated in the case where the calculated temperature of the object to be heated is equal to or higher than the conversion temperature.

As one aspect of the heating simulation method according to the present invention, the temperature change of the object to be heated may be calculated using the second physical property value as the physical property value of the object to be heated in the case where the temperature of the object to be heated that is being calculated reaches the conversion temperature or higher, irrespective of temperatures subsequently calculated.

The heating simulation program according to the present invention is a heating simulation program for causing an arithmetic unit to execute calculation of temperature change of an object to be heated under a predetermined heating condition, the heating simulation program causing the arithmetic unit to execute: a step of receiving settings of a first physical property value and a second physical property value as a physical property value of the object to be heated; a step of receiving a setting of a temperature at which the physical property value of the object to be heated changes from the first physical property value to the second physical property value, as a conversion temperature; a step of determining whether a calculated temperature of the object to be heated is equal to or higher than the conversion temperature; a step of calculating the temperature change of the object to be heated using the first physical property value as the physical property value of the object to be heated in the case where the calculated temperature of the object to be heated is lower than the conversion temperature; and a step of calculating the temperature change of the object to be heated using the second physical property value as the physical property value of the object to be heated in the case where the calculated temperature of the object to be heated is equal to or higher than the conversion temperature.

The heating simulator according to the present invention includes a storage medium having the heating simulation program stored therein, and is configured to cause the arithmetic unit to run the heating simulation program.

According to the simulation method of the present invention, the estimated temperatures approximate to the actual temperature change of the object can be calculated.

### BRIEF DESCRIPTION OF DRAWINGS

FIG. 1 is a flow chart of calculating an estimated temperature according to an embodiment of the present invention.

FIG. 2 is a graph showing a measured temperature history and an estimated temperature history, of an object according to a comparative example of the present invention.

FIG. 3 is a graph showing a measured temperature history and an estimated temperature history, of an object according to an embodiment of the present invention.

### DESCRIPTION OF EMBODIMENTS

Hereinafter, the heating simulation method of the present invention will be described with reference to the attached drawings. The simulation method of this embodiment is performed by a simulator that includes a storage medium in which a program capable of executing the simulation method is stored, and an arithmetic unit (CPU) for running the program. A result of the simulation is, for example, displayed on a display provided to the simulator, and stored in a memory card.

In the heating simulation method of the present invention, temperature change of an object to be heated under a predetermined heating condition is obtained by calculation. The heating simulation method of this embodiment is suitable for calculating an estimated temperature of an object of which physical properties are changed by heating, in particular, an object of which specific heat is changed by heating. Examples of such an object include egg tofu. In this case, the ingredient liquid containing liquid egg at the starting point of heating is changed to egg tofu by heating. In this way, the change in the state of the object from a liquid state to a gel state by heating results also in a change in the specific heat of the object and a change in a physical property value for calculating the estimated temperature of the object. Note that in the case where the object contains protein such as the liquid egg, which is denatured by heating, the physical properties of the object that have once been changed by heating will not return to the original physical properties even after the object is cooled.

Bearing the above in mind, in the heating simulation method of the present invention, a first physical property value and a second physical property value are each set as the physical property value of the object to be heated, a temperature at which the physical property value of the object to be heated changes from the first physical property value to the second physical property value is set as a conversion temperature, the temperature change of the object to be heated is calculated using the first physical property value as the physical property value of the object to be heated in the case where a calculated temperature of the object to be heated is lower than the conversion temperature, and the temperature change of the object to be heated is calculated using the second physical property value as the physical property value of the object to be heated in the case where the calculated temperature of the object to be heated is equal to or higher than the conversion temperature. Hereinafter, the specific steps in the heating simulation method of this embodiment will be described.

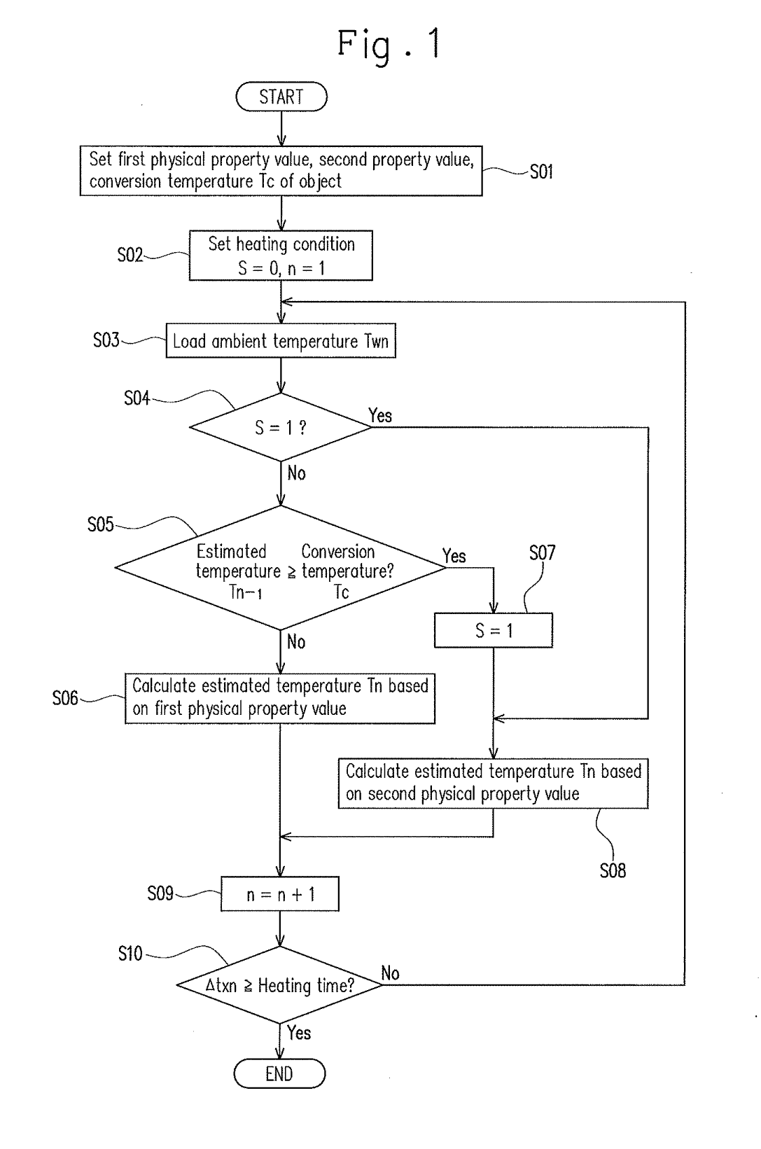

As shown in the flowchart of FIG. 1, the heating simulation method of this embodiment (hereinafter referred to as the simulation method) includes: a step (S01) in which the first and second physical property values of the object, and a conversion temperature T_{c} are set to a heating simulator (hereinafter referred to as the simulator); a step (S02) in which a heating condition is set to the simulator and the simulator sets a status flag S to 0 and sets n to 1; a step (S03) in which the simulator loads an ambient temperature T_{wn} from the heating condition; a step (S04) in which the simulator determines “whether the status flag S is 1”; a step (S05) in which the simulator determines “whether an estimated temperature Tₙ₋₁ is equal to or higher than the conversion temperature T_{c}”; a step (S06) in which the simulator calculates an estimated temperature Tₙ based on the first physical property value; a step (S07) in which the simulator sets the status flag S to 1; a step (S08) in which the simulator calculates the estimated temperature Tₙ based on the second physical property value; a step (S09) in which the simulator adds 1 to n; and a step (S10) in which the simulator determines “whether Δt×n is equal to or longer than heating time”. The status flag S is a flag showing that the estimated temperature of the object has previously reached the conversion temperature. Δt represents a unit time, and n represents the nth interval in intervals of time. In this embodiment, it is assumed that the estimated temperature is uniform across the entirety of the object.

Hereinafter, each of the steps included in the simulation method of this embodiment will be described in order. This embodiment will be described by taking, for example, the case where the ATS method (Ambient Temperature Slide method), a method for calculating the temperature of a central portion of the object, is employed as a method for calculating the estimated temperature of the object. Note that the central portion in this context does not refer to the physical center of the object but to a portion in which a rise or fall in temperature occurs lastly.

First, a summary of the ATS method will be described. It is premised in the ATS method that the temperature of the object rises with heat transfer from the atmosphere. Calculations are made based on the premise that the “amount of heat the atmosphere transfers to the object” equals the “amount of heat the object receives from the atmosphere”. Where, as aforementioned, the unit time is Δt, the central point of the object is a central point P, the ambient temperature and a central point temperature of the object are respectively T_{wn} and Tₚₙ (the subscript n represents the nth interval in intervals of time, similar to the aforementioned n), the surface temperature of the object equals the ambient temperature T_{wn}, a linear temperature gradient is caused inside the object, the distance from the surface of the object to the central point is L, the thermal conductivity of the object is k, and the surface area of the object is A, the “amount of heat the atmosphere transfers to the object” per unit time, i.e., the left side of the formula below, is obtained.

In addition, where the volume of the object is V, the density of the object is ρ, the specific heat of the object is cₚ, and a central point temperature Tₚₙ equals a volume average temperature Tₚ*ₙ, the “amount of heat the object receives from the atmosphere” per unit time, i.e., the right side of the formula below, is obtained:

kA(T_{wn-1}−Tₚₙ₋₁)Δt/L=Vρcₚ(Tₚ*ₙ−Tₚ*ₙ₋₁)

When the formula above is arranged assuming that k/(ρcₚ) is a thermal diffusivity coefficient α, the formula below is given:

Tₚ*ₙ=Tₚ*ₙ₋₁+αΔt(T_{wn-1}−Tₚₙ₋₁)/L²

Since the central point temperature Tₚₙ actually differs from the volume average temperature Tₚ*ₙ, a deviation ratio β between the central point temperature Tₚₙ and the volume average temperature Tₚ*ₙ is used to make Tₚₙ=Tₚ*ₙ=, so that the formula below is given:

Tₚₙ=Tₚₙ₋₁+αβΔt(T_{wn-1}−Tₚₙ₋₁)/L²

Further, where αβΔt/L² is a heat transfer coefficient τ, the formula below is given. The formula below expresses that rise in the central point temperature corresponds to the product of multiplication of the heat transfer coefficient τ and the difference between a surface temperature T_{wn-1} and a central point temperature Tₚₙ₋₁, of the object, per unit time:

Tₚₙ=Tₚₙ₋₁+τ(T_{wn-1}−Tₚₙ₋₁)

In the actual object, however, the surface thereof is located away from the central point; thus, temperature change of the central point is delayed compared to temperature change of the surface. This delay is not reflected in the formula above. Therefore, in the formula above, a virtual ambient temperature (t-δ)T_{wn-1} obtained by delaying temporal change of an ambient temperature T_{wn-1} by δ is used as the surface temperature instead of the ambient temperature T_{wn-1}, so that the formula below is given:

Tₚₙ=Tₚₙ₋₁+τ₁((t−δ)T_{wn-1}−Tₚₙ₋₁)

Thus, in the case where the ATS method is employed, the heat transfer coefficient τ and a delay time δ are set as the physical property values in step S01. Specifically, in step S01, the first physical property values (i.e., a first heat transfer coefficient τ₁ and a first delay time δ₁), the second physical property values (i.e., a second heat transfer coefficient τ₂ and a second delay time 62), and the conversion temperature T_{c} are set to the simulator by, for example, a user's input. The heat transfer coefficient τ and the delay time δ are determined by a material forming the object, a shape of the object, and a state of the object. The conversion temperature T_{c} is a temperature at which the first and second physical property values are converted. The user inputs the data of the first physical property values (i.e., the first heat transfer coefficient τ₁ and the first delay time δ₁), the second physical property values (i.e., the second heat transfer coefficient τ₂ and the second delay time δ₂), and the conversion temperature T_{c} to the simulator if the user has the data. If the user does not have the data, the user obtains the data of the first physical property values (i.e., the first heat transfer coefficient τ₁ and the first delay time δ₁), the second physical property values (i.e., the second heat transfer coefficient τ₂ and the second delay time δ₂), and the conversion temperature T_{c}, and inputs the data to the simulator.

To obtain the first physical property values, the second physical property values, and the conversion temperature T_{c}, the conversion temperature T_{c} is first obtained, then the first physical property values are obtained for the case where the estimated temperature of the object is lower than the conversion temperature T_{c}, and further the second physical property values are obtained for the case where the estimated temperature of the object is equal to or higher than the conversion temperature T_{c}. Hereinafter, a method for obtaining the conversion temperature T_{c} and a method for obtaining the first and second physical property values will be described in order.

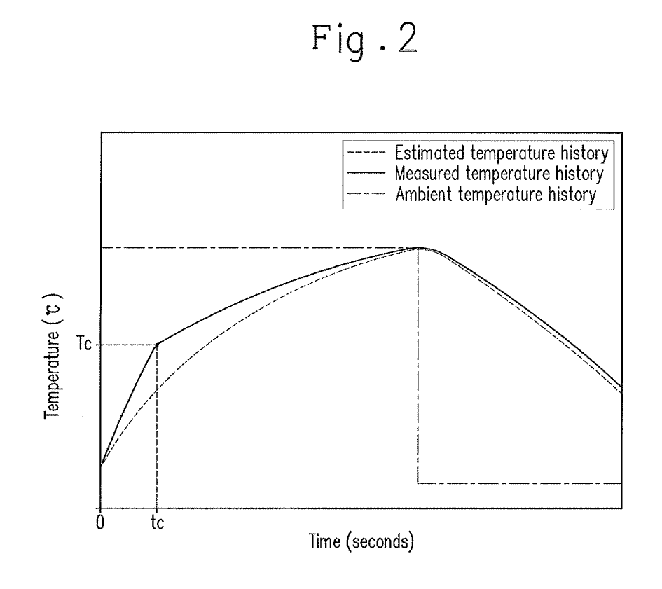

The conversion temperature T_{c} is obtained by comparison of the measured temperature with the estimated temperature calculated based on estimated physical property values (i.e., estimated values of the heat transfer coefficient τ and the delay time δ). This will be described using the graph of FIG. 2. This graph shows the temperature changes of the object relative to the heating condition of the object. The horizontal axis of the graph represents time (in seconds), and the vertical axis of the graph represents temperature (in ° C.). The dot-and-dash line shows the ambient temperature T_{wn} predetermined as the heating condition. In this embodiment, the ambient temperature T_{wn} at the time of heating is constant, and the ambient temperature T_{wn} at the time of cooling is also constant. The solid line shows the measured temperature history obtained by plotting the measured temperatures of the object. The dotted line shows an estimated temperature history obtained by plotting the estimated temperatures calculated based on the estimated physical property values (the estimated values of the heat transfer coefficient τ and the delay time δ). The conversion temperature T_{c} is obtained as a measured temperature at a time t_{c} when the difference between the estimated temperature and the measured temperature is maximized, in the case where the measured temperature history at the time of heating has a shape with an upward projection and the estimated temperature history is positioned on the lower side of the measured temperatures, as is the case of this graph. In this context, the upper side refers to the higher temperature side, and the lower side refers to the lower temperature side.

Some estimated physical property values may cause the estimated temperature history to be positioned on the upper side of the measured temperature history. In this case, such estimated physical property values are corrected so that the estimated temperature history is positioned on the lower side of the measured temperature history, the estimated temperature is calculated based on the estimated physical property values that have been corrected, and the conversion temperature is calculated by the difference between the corrected estimated temperature history and the measured temperature history.

Further, some objects may cause the measured temperature history at the time of heating to have a shape with a downward projection. In this case, the estimated temperature may be calculated based on the estimated physical property values that are selected so as to position the estimated temperature history on the upper side of the measured temperature history. In this case also, the conversion temperature T_{c} is obtained as the measured temperature at the time t_{c} when the difference between the estimated temperature and the measured temperature is maximized.

To obtain the first physical property values (i.e., the first heat transfer coefficient τ₁ and the first delay time δ₁), a trial-and-error method is used in which the user estimates a given heat transfer coefficient τ and a given delay time δ, calculates the estimated temperature Tₙ using the ATS method based on the estimated values, compares the estimated temperature Tₙ with the measured temperature to correct the estimated heat transfer coefficient τ and the estimated delay time δ, recalculates the estimated temperature Tₙ based on the corrected heat transfer coefficient τ and the corrected delay time δ, and repeatedly performs these until the estimated temperature Tₙ is approximated to the measured temperature. In this way, the appropriate first physical property values (i.e., the first heat transfer coefficient τ₁ and the first delay time δ₁) can be obtained. The measured temperature of the object is measured using a temperature detecting sensor such as a thermistor.

Hereinafter, a specific method for obtaining the first physical property values will be described. When, for example, the heat transfer coefficient τ is unknown, an estimated temperature T′ₙ is calculated based on an estimated heat transfer coefficient τ′₁ to calculate the difference between the estimated temperature T′ₙ and the measured temperature. When the difference between the estimated temperature T′ₙ and the measured temperature is equal to or less than a desired value, the heat transfer coefficient τ′₁ is employed as the first heat transfer coefficient τ₁.

When the difference between the estimated temperature T′ₙ and the measured temperature is greater than the desired value, four heat transfer coefficients τ″₁ close to the heat transfer coefficient τ′₁ are set to calculate estimated temperatures T″ₙ respectively based on the four heat transfer coefficients τ″₁ and calculate the difference between each of the four estimated temperatures T″ₙ and the measured temperature.

When the smallest one of the differences between the four estimated temperatures T″ₙ and the measured temperature is smaller than the difference between the estimated temperature T′ₙ and the measured temperature and is smaller than the desired value, then the heat transfer coefficient τ″₁ used for calculating the smallest one of the differences between the four estimated temperatures T″ₙ and the measured temperature is employed as the first heat transfer coefficient τ₁.

When the smallest one of the differences between the four estimated temperatures T″ₙ and the measured temperature is smaller than the difference between the estimated temperature T′ₙ and the measured temperature and is greater than the desired value, then four heat transfer coefficients τ′″₁ that are close to the heat transfer coefficient τ″₁ used for calculating the smallest one of the differences between the four estimated temperatures T″ₙ and the measured temperature are set again to repeatedly carry out a series of calculations, such as calculations of estimated temperatures T′″ₙ respectively based on the four heat transfer coefficients τ′″₁.

As described above, the heat transfer coefficient τ′₁ can be obtained using the trial-and-error method in which a series of calculations are repeatedly carried out.

The second physical property values are also obtained using the aforementioned trial-and-error method.

In step S02, the heating condition of the object is set to the simulator by, for example, a user's input. Examples of the heating condition include the ambient temperature T_{wn} and the heating time. Further, the simulator sets the status flag S to 0, and sets n to 1.

In step S03, the simulator loads the ambient temperature T_{wn} from the heating condition, and sets the ambient temperature T_{wn} used in step S06 or step S08. When, for example, the ambient temperature T_{wn} differs from the ambient temperature T_{wn-1}, the ambient temperature used in step S06 or step S08 is changed to the ambient temperature T_{wn}.

After the simulator determines “whether the status flag S is 1” in step S04, the simulator determines “whether the estimated temperature Tₙ₋₁ is equal to or higher than the conversion temperature T_{c}” in step S05. In step S04, it is determined whether the estimated temperature of the object has previously reached the conversion temperature. In order to show that the estimated temperature of the object has previously reached the conversion temperature, the status flag S is set to 1, as aforementioned, if Yes in step S05. In step S05, it is determined whether the estimated temperature Tₙ₋₁ is lower than the conversion temperature T_{c}, or is equal to or higher than the conversion temperature T_{c}.

If No in step S04 and No in step S05, that is, when the estimated temperature of the object has never reached the conversion temperature and the estimated temperature Tₙ₋₁ is lower than the conversion temperature T_{c}, the simulator calculates the estimated temperature Tₙ in step S06, based on the first physical property values (i.e., the first heat transfer coefficient τ₁ and the first delay time δ₁) using the formula below derived from the ATS method:

Tₚₙ=Tₚₙ₋₁+τ₁((t−δ₁)T_{wn-1}−Tₚₙ₋₁)

If No in step S04 and Yes in step S05, that is, when the estimated temperature of the object has never reached the conversion temperature and the estimated temperature Tₙ₋₁ is equal to or higher than the conversion temperature T_{c}, the status flag S is set to 1 in step S07, and then the simulator calculates the estimated temperature Tₙ in step S08, based on the second physical property values (i.e., the second heat transfer coefficient τ₂ and the second delay time δ₂) using the formula below derived from the ATS method:

Tₚₙ=Tₚₙ₋₁+τ₂((t−δ₂)T_{wn-1}−Tₚₙ₋₁)

If Yes in step S04, that is, when the estimated temperature of the object has previously reached the conversion temperature T_{c}, the simulator calculates the estimated temperature Tₙ in step S08, based on the second physical property values (i.e., the second heat transfer coefficient τ₂ and the second delay time δ₂) using the formula below derived from the ATS method:

Tₚₙ=Tₚₙ₋₁+τ₂((t−δ₂)T_{W-1}−Tₚₙ₋₁)

That is, temperature change of the object is calculated using the second physical property values (i.e., the second heat transfer coefficient τ₂ and the second delay time δ₂) as the physical property values of the object when the temperature of the object that is being calculated is equal to or higher than the conversion temperature T_{c}, irrespective of temperatures subsequently calculated.

The simulator adds 1 to n in step S09, and then the simulator determines “whether Δt×n is equal to or longer than the heating time” in step S10.

If No in step S10, that is, when Δt× n is shorter than the heating time, the simulator repeats step S03 to step S09.

If Yes in step S10, that is, when Δt× n is equal to or longer than the heating time, the simulator ends performing the simulation method.

As described above, the estimated temperatures of the object approximate to the actual temperature change of the object can be calculated through the simulation method according to this embodiment. The estimated temperature is used as, for example, an index for evaluating heating conditions of food from the viewpoint of sterilization. Hereinafter, the evaluation of the heating conditions of food using the estimated temperature as the index will be described from the viewpoint of sterilization.

Whether or not a certain heating condition is suitable from the viewpoint of food sterilization is generally evaluated based on whether the temperature history of food during the heating meets an F-value that is an integrated value of sterilization evaluation. It is preferable from the viewpoint of sterilization to evaluate the temperature of a central portion of food, which is less likely to receive heat from the atmosphere and is least likely to be sterilized. Thus, in order to evaluate the heating condition from the viewpoint of sterilization, an estimated temperature history T is obtained from the estimated temperatures Tₙ in the central portion of food to evaluate whether the estimated temperature history T is equivalent to the specified F-value. Hereinafter, effects of this embodiment will be collectively described.

In the simulation method of this embodiment, the estimated temperature Tₙ is calculated based on the first physical property values (i.e., the first heat transfer coefficient τ₁ and the first delay time δ₁) in the case where the estimated temperature of the object is lower than the conversion temperature T_{c}, and the estimated temperature Tₙ is calculated based on the second physical property values (i.e., the second heat transfer coefficient τ₂ and the second delay time δ₂) in the case where the estimated temperature of the object is equal to or higher than the conversion temperature T_{c}. Therefore, in the abovementioned simulation method, the estimated temperatures more approximate to the actual temperature change of the object are calculated.

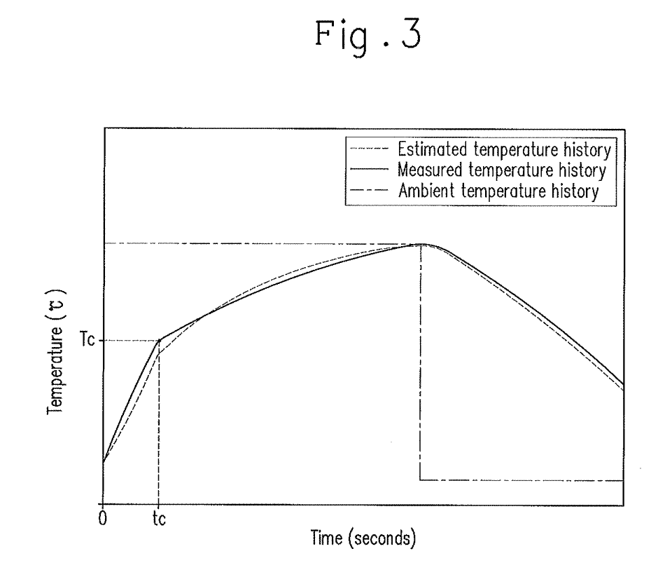

For example, FIG. 3 is a graph showing a history of the estimated temperature calculated through the simulation method of this embodiment (i.e., a graph showing temperature changes of the object relative to the heating condition of the object). In FIG. 3, similar to FIG. 2, the horizontal axis of the graph represents time (in seconds), and the vertical axis of the graph represents temperature (in ° C.). The dot-and-dash line shows the ambient temperature T_{wn} predetermined as the heating condition. The comparative example and this embodiment share the same ambient temperature. The solid line shows the measured temperature history obtained by plotting the measured temperatures of the object. The dotted line shows the estimated temperature history calculated through each simulation method. The estimated temperature history calculated in the simulation method of this embodiment is more approximate to the measured temperature history (i.e., the history of the actual temperature change of the object) than that calculated in the simulation method of the comparative example.

The simulation method of this embodiment includes step S04 for determining whether the estimated temperature has previously reached the conversion temperature, between step S02 in which the heating condition is set and step S05 for determination of the estimated temperature Tₙ and the conversion temperature T_{c}. When the estimated temperature of the object has previously reached the conversion temperature T_{c} (i.e., the status flag S is 1), the estimated temperature Tₙ of the object is calculated based on the second physical property values, instead of the execution of steps S05-S08. That is, the temperature change of the object is calculated using the second physical property values as the physical property values of the object in the case where the temperature of the object being calculated reaches the conversion temperature T_{c} or higher, irrespective of temperatures subsequently calculated. This simulation method is suitable for the case where the physical properties of the object that have once changed do not return to the original properties even after the object is further heated or cooled. Thus, in the aforementioned simulation method, the estimated temperatures more approximate to the actual temperature change of the object are calculated, even in the case where the object is, for example, egg tofu that includes liquid egg in the ingredients.

The simulation method according to the present invention is not limited to the configuration of the aforementioned embodiment, but various modifications can be made without departing from the gist of the present invention.

The aforementioned embodiment has been described by taking, for example, the case where there is one conversion temperature and an estimated temperature is calculated based on the first and second physical property values, without limitation thereto. There may be two or more conversion temperatures, and the estimated temperature may be calculated based on three or more physical property values, i.e., first, second, third physical property values.

The aforementioned embodiment has been described by taking, for example, the case where both the heat transfer coefficient τ and the delay time δ are used as the first and second physical property values, without limitation thereto. For example, only the heat transfer coefficient τ may be used as the first and second physical property values in the case where the heat transfer coefficient τ changes but the delay time δ does not change, before and after the conversion temperature is reached.

The aforementioned embodiment has been described by taking, for example, the case where the conversion temperature is a temperature at which the difference between the measured temperature and the estimated temperature is maximized, without limitation thereto. For example, the conversion temperature may be a temperature at which the average ratio of the difference between the measured temperature and the estimated temperature relative to the measured temperature is maximized. That is, the ratio of the difference can be obtained by the formula below. In the case where the value calculated by (measured temperature−estimated temperature) is negative, the absolute value thereof is used:

{(Measured temperature−Estimated temperature)/Measured temperature}×100

The aforementioned embodiment has been described by taking, for example, the case where the conversion temperature is obtained based on one criterion, without limitation thereto. For example, the configuration may be such that a first conversion temperature at which the difference between the measured temperature and the estimated temperature is maximized, and a second conversion temperature at which the average ratio of the difference between the measured temperature and the estimated temperature relative to the measured temperature is maximized are respectively obtained to calculate estimated temperatures based on the first and second conversion temperatures, and either of the first or second conversion temperature that has a calculated estimated temperature closer to the measured temperature, is used.

In obtaining the first physical property values, the second physical property values, and the conversion temperature T_{c} in the aforementioned embodiment, the conversion temperature T_{c} is first obtained, followed by obtaining the first physical property values corresponding to a temperature lower than the conversion temperature T_{c}, and then the second physical property values corresponding to a temperature equal to or higher than the conversion temperature T_{c}. However, the order of obtaining these may be different from the aforementioned order, and the first and second physical property values may be simultaneously obtained.

The aforementioned embodiment has been described by taking, for example, the case where the ambient temperature T_{wn} at the time of heating is constant and the ambient temperature T_{wn} at the time of cooling is also constant, without limitation thereto. A plural kinds of ambient temperatures may be set at the time of heating and at the time of cooling, respectively.

The aforementioned embodiment has been described by taking, for example, the case where the object is egg tofu, without limitation thereto. The object may be, for example, other packed food such as retort food and canned food, and an object other than food such as a medicinal product.

The aforementioned embodiment has been described by taking, for example, the case where the object has the conversion temperature in the course of being heated, without limitation thereto. For example, some objects may have a conversion temperature in the course of being cooled. Examples of these objects include jelly, of which the state is changed by cooling. For such an object as jelly, the simulation method may be used to determine whether or not the estimated temperature of the object is equal to or higher than the conversion temperature, and calculate the estimated temperatures in both cases, based on different physical property values.

The aforementioned embodiment has been described by taking, for example, the case where the physical properties of the object that have once changed are not changed by further heating or cooling of the object, without limitation thereto. For example, in the case where the object is jelly, the object is in the gel state at the time heating starts, is changed into the liquid state while being heated, and is returned to the gel state after being cooled. In the simulation method in this case, step S04 for determining the status flag in the flow chart of FIG. 1 is not executed, and the estimated temperature Tₙ may be calculated based on the first physical property values or the second physical property values through determination of the estimated temperature and the conversion temperature T_{c}, even when the estimated temperature reaches the conversion temperature T_{c}. In this case, therefore, the estimated temperature Tₙ is calculated based on the first physical property values when the calculated estimated temperature of the object is lower than the conversion temperature T_{c}.

The aforementioned embodiment has been described by taking, for example, the case where the estimated temperature is calculated based on the same second physical property values in the heating process and the cooling process since the object shares the same state in both processes, without limitation thereto. For example, in the case where the object is in the same state but has actual temperature changes being different between the heating process and the cooling process, the estimated temperatures may be calculated based on the different physical property values in the heating process and the cooling process, so as to meet the case.

The aforementioned embodiment has been described by taking, for example, the case where the estimated temperature is calculated using the ATS method, without limitation thereto. For example, the estimated temperature may be calculated using other methods such as Ball's formula method.

The simulator of the aforementioned embodiment may be an apparatus provided separately from an apparatus for heating the object, or may be integrated into the apparatus for heating the object.

As described above, the heating simulation method according to the present invention is a heating simulation method for obtaining, by calculation, temperature change of an object to be heated under a predetermined heating condition, which includes: setting a first physical property value and a second physical property value as a physical property value of the object to be heated; setting a temperature at which the physical property value of the object to be heated changes from the first physical property value to the second physical property value, as a conversion temperature; calculating the temperature change of the object to be heated using the first physical property value as the physical property value of the object to be heated in the case where a calculated temperature of the object to be heated is lower than the conversion temperature; and calculating the temperature change of the object to be heated using the second physical property value as the physical property value of the object to be heated in the case where the calculated temperature of the object to be heated is equal to or higher than the conversion temperature.

In the aforementioned heating simulation method, the temperature change is calculated based on the first physical property value in the case where the estimated temperature of the object is lower than the conversion temperature, and the temperature change is calculated based on the second physical property value in the case where the estimated temperature of the object is equal to or higher than the conversion temperature. As a result, the heating simulation method in which the estimated temperatures more approximate to the actual temperature change of the object are calculated can be provided.

As one aspect of the heating simulation method according to the present invention, the temperature change of the object to be heated may be calculated using the second physical property value as the physical property value of the object to be heated in the case where the temperature of the object to be heated that is being calculated reaches the conversion temperature or higher, irrespective of temperatures subsequently calculated.

In the aforementioned simulation method, the temperature change of the object is calculated based on the second physical property value if the estimated temperature of the object has previously reached the conversion temperature. Thus, this simulation method is suitable for the case where the physical properties of the object that have once changed do not return to the original properties even after the object is further heated or cooled. As a result, the heating simulation method in which the estimated temperatures more approximate to the actual temperature change of the object are calculated can be provided, even in the case where the object is, for example, egg tofu that includes liquid egg in the ingredients.

The heating simulation program according to the present invention is a heating simulation program for causing an arithmetic unit to execute calculation of temperature change of an object to be heated under a predetermined heating condition, the heating simulation program causing the arithmetic unit to execute: a step of receiving settings of a first physical property value and a second physical property value as a physical property value of the object to be heated; a step of receiving a setting of a temperature at which the physical property value of the object to be heated changes from the first physical property value to the second physical property value, as a conversion temperature; a step of determining whether a calculated temperature of the object to be heated is equal to or higher than the conversion temperature; a step of calculating the temperature change of the object to be heated using the first physical property value as the physical property value of the object to be heated in the case where the calculated temperature of the object to be heated is lower than the conversion temperature; and a step of calculating the temperature change of the object to be heated using the second physical property value as the physical property value of the object to be heated in the case where the calculated temperature of the object to be heated is equal to or higher than the conversion temperature.

In the aforementioned program, the temperature change is calculated based on the first physical property value in the case where the estimated temperature of the object is lower than the conversion temperature, and the temperature change is calculated based on the second physical property value in the case where the estimated temperature of the object is equal to or higher than the conversion temperature. As a result, the program configured to calculate the estimated temperatures more approximate to the actual temperature change of the object can be provided.

The heating simulator according to the present invention includes a storage medium having the heating simulation program stored therein, and is configured to cause the arithmetic unit to run the heating simulation program.

In the aforementioned simulator, the temperature change is calculated based on the first physical property value in the case where the estimated temperature of the object is lower than the conversion temperature, and the temperature change is calculated based on the second physical property value in the case where the estimated temperature of the object is equal to or higher than the conversion temperature. As a result, the simulator configured to calculate the estimated temperatures more approximate to the actual temperature change of the object can be provided.

### INDUSTRIAL APPLICABILITY

The simulation method of the present invention is applicable to calculating temperature change resulting from heating of retort food, canned food, medicinal products, or the like.

### REFERENCE SIGNS LIST

1: T_{c} . . . Conversion temperature
2: Tₙ . . . Estimated temperature
3: T_{wn} . . . Ambient temperature

1. A heating simulation method for obtaining, by calculation, temperature change of an object to be heated under a predetermined heating condition, which comprises:
setting a first physical property value and a second physical property value as a physical property value of the object to be heated;
setting a temperature at which the physical property value of the object to be heated changes from the first physical property value to the second physical property value, as a conversion temperature;
calculating the temperature change of the object to be heated using the first physical property value as the physical property value of the object to be heated in the case where a calculated temperature of the object to be heated is lower than the conversion temperature; and
calculating the temperature change of the object to be heated using the second physical property value as the physical property value of the object to be heated in the case where the calculated temperature of the object to be heated is equal to or higher than the conversion temperature.

2. The heating simulation method according to claim 1, wherein
the temperature change of the object to be heated is calculated using the second physical property value as the physical property value of the object to be heated in the case where the temperature of the object to be heated that is being calculated reaches the conversion temperature or higher, irrespective of temperatures subsequently calculated.

3. A heating simulation program for causing an arithmetic unit to execute calculation of temperature change of an object to be heated under a predetermined heating condition, the heating simulation program causing the arithmetic unit to execute:
a step of receiving settings of a first physical property value and a second physical property value as a physical property value of the object to be heated;
a step of receiving a setting of a temperature at which the physical property value of the object to be heated changes from the first physical property value to the second physical property value, as a conversion temperature;
a step of determining whether a calculated temperature of the object to be heated is equal to or higher than the conversion temperature;
a step of calculating the temperature change of the object to be heated using the first physical property value as the physical property value of the object to be heated, in the case where the calculated temperature of the object to be heated is lower than the conversion temperature; and
a step of calculating the temperature change of the object to be heated using the second physical property value as the physical property value of the object to be heated, in the case where the calculated temperature of the object to be heated is equal to or higher than the conversion temperature.

4. A heating simulator, comprising:
a storage medium having the heating simulation program according to claim 3 stored therein, wherein
the heating simulator is configured to cause the arithmetic unit to run the heating simulation program.
